(19) United States
(12) Patent Application Publication
(10) Pub. No.: US 2005/0167995 A1
(43) Pub. Date: Aug. 4, 2005

(54) Locking mechanism

(76) Inventors: Glen William Wallis, Staffs (GB); Rob Todd, Newcastle Upon Tyme (GB)

Correspondence Address: MICHAEL BEST & FRIEDRICH, LLP, 100 E WISCONSIN AVENUE, MILWAUKEE, WI, 53202, US

(21) Appl. No.: 10/501,379

(22) PCT Filed: Jan. 13, 2003
(86) PCT No.: PCT/GB03/00111

(30) Foreign Application Priority Data
Jan. 14, 2002 (GB) 0200677.3

(51) Int. Cl. E05B 3/00

(52) U.S. Cl. 292/336.3

(57) ABSTRACT

A locking mechanism is provided for use with at least one door and/or window (10) of a structure, the mechanism comprising at least one operating handle (12) and at least one electrical operating device (14). The operating device may comprise a fob (14) which may be manually operated, e.g. by a householder, from outside a building, to unlock a door or window. In a preferred embodiment, the locking mechanism comprises a first rotatable member (23) associated with the handle, a second rotatable member (24) spaced from the first rotatable member (23) and associated with a dead bold (18) and a control member (28) extending between the first and second rotatable members.

The invention relates to locking mechanisms and particularly to locking mechanisms for use with structures, for example to lock at least one door and/or window of a building such as a domestic home.

The invention provides a locking mechanism for use with at least one door and/or window of a structure, the mechanism comprising at least one operating handle and at least one electrical operating device.

The electrical operating device may comprise at least one remote control device.

The remote control device may comprise a fob which may be manually operated, e.g. by a householder from outside a building, to unlock a door or window.

Preferably, the locking mechanism comprises a first rotatable member associated with the handle, a second rotatable member spaced from the first rotatable member and associated with a dead bolt, and a control member extending between the first and second rotatable members.

The second rotatable member may be movable into a locking position in which it causes the control member to prevent operation of the handle.

The second control member is preferably rotatable by means of a motor.

The motor is preferably associated with a gear train which provides a high mechanical advantage in favour of the motor, for example by incorporating a worm.

The locking mechanism preferably incorporates a first clutch to enable the second operating member to be manually rotated if desired, notwithstanding the connection of the second rotatable member to the motor.

The locking mechanism may incorporate a second clutch arranged to slip once the motor has moved the second rotatable member to a predetermined position, the change in electrical current to the motor, on slippage of the second clutch, providing a readily detectable and identifiable signal indicating that the motor has achieved its function.

The control member may comprise a control link which, when the second rotatable member is in the locking position, is locked against movement by a cam associated with the second rotatable member, the other end of the control member locking the handle against movement.

The control member may operate to lock the handle against movement by the engagement of a projection in a recess.

Preferably, there is an internal handle and an external handle, both of which are locked against movement when the second rotatable member is in the locking position.

The cam may have a day latch position in which it does not prevent movement of the control member, but the control member is biased into a locking position.

Preferably, when the control member is biased into the locking position, the external handle cannot be moved, but the projection and recess locking the internal handle are such that there is a ramp surface so that the internal handle can be moved, the associated projection riding along the ramp and out of the recess.

This enables a house door, for example, to be put into a condition in which the door can be immediately opened from inside the house without any key or fob, but the door cannot be opened from outside the house without use of the fob.

Preferably the locking mechanism is such that operation of the fob causes the control member to move into a position in which the projection is clear of the recess and both the internal and external handles can be operated.

The locking mechanism may be such that after a door has been opened using the fob, and then closed, the locking mechanism moves into the day latch condition.

There may be a short delay before the locking mechanism moves into the day latch position, for example from 5 to 10 seconds.

The locking mechanism may be associated with internal safety devices, for example at least one smoke detector, at least one burglar alarm and at least one panic button.

The locking mechanism may be linked to other locking mechanisms on other door and/or windows, so that several entry points on a structure may be controlled from a single locking mechanism, for example using the fob associated with that locking mechanism.

The second rotatable member may be manually rotatable by a knob, the knob being arranged so that it is difficult for a small child to operate.

For example it may be necessary to press the knob in and keep the knob pressed in before it is turned.

The locking mechanism may be such that pressing the knob in causes one drive gear associated with the second rotatable mechanism to engage with another such drive gear.

The invention includes a moveable panel such as a door or window, fitted with an embodiment of locking mechanism according to the invention.

The invention includes a structure fitted with a locking mechanism according to the invention.

By way of example, a specific embodiment of the invention will now be described, with reference to the accompanying figures, in which:

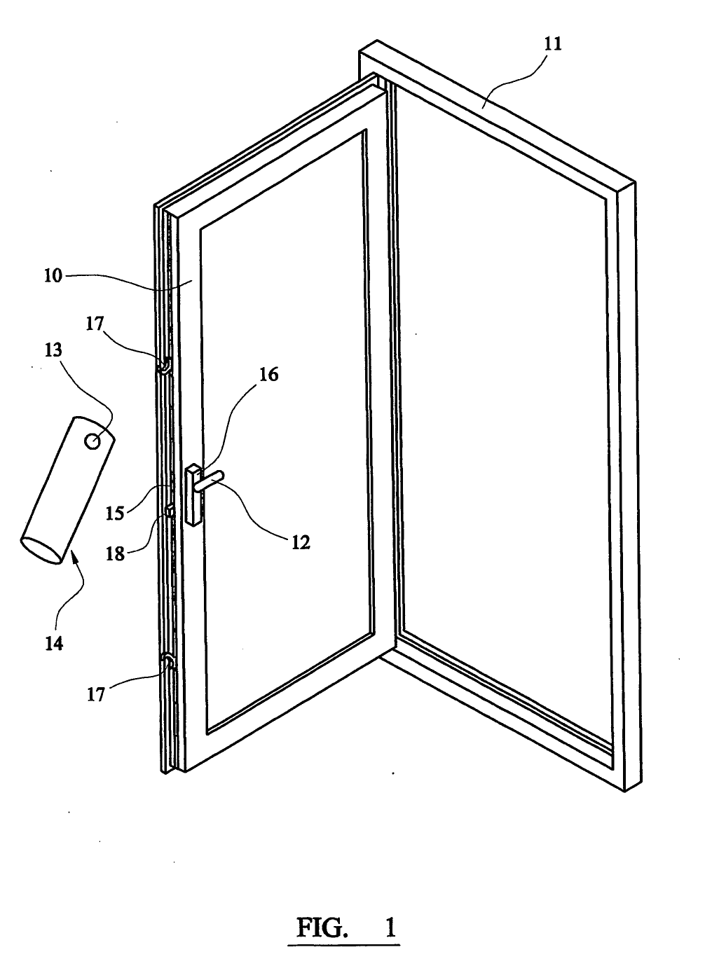

FIG. 1 is a diagrammatic illustration of a door fitted with an embodiment of locking mechanism according to the invention;

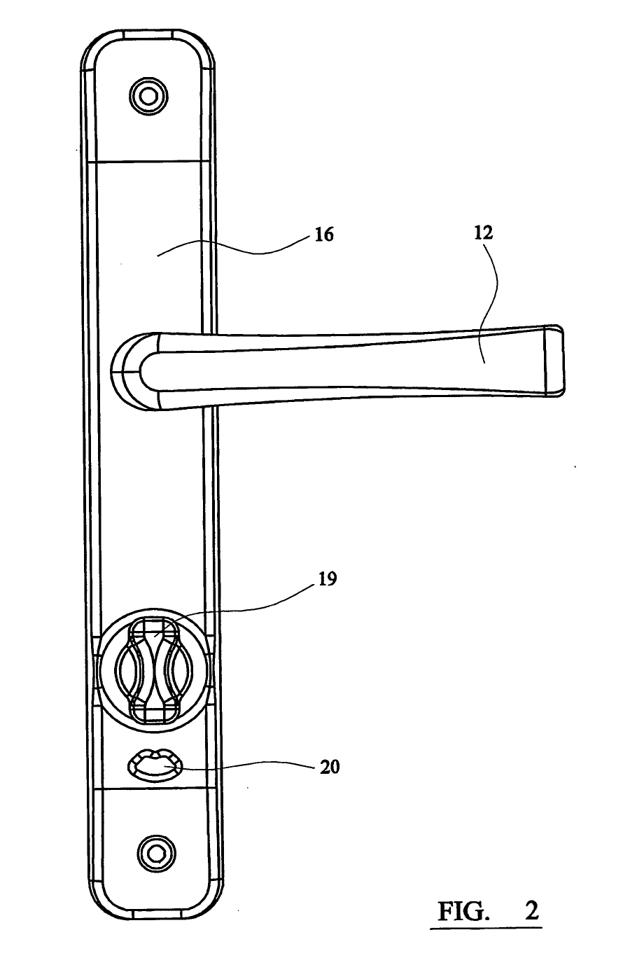

FIG. 2 is a front view of the entire assembly of the locking mechanism as it would appear from inside a building;

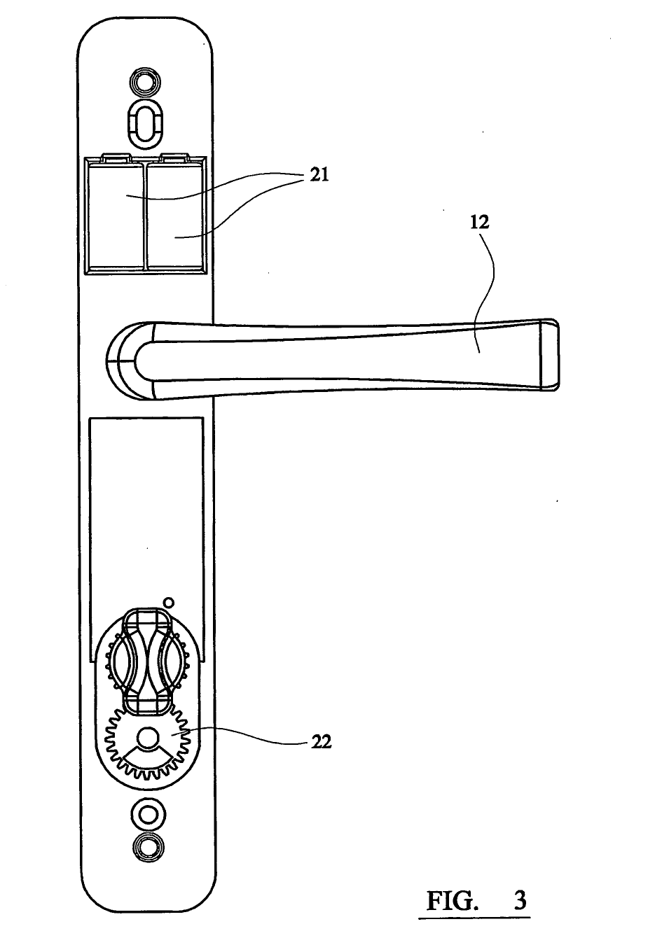

FIG. 3 is a view similar to FIG. 2 but with an inside back plate removed;

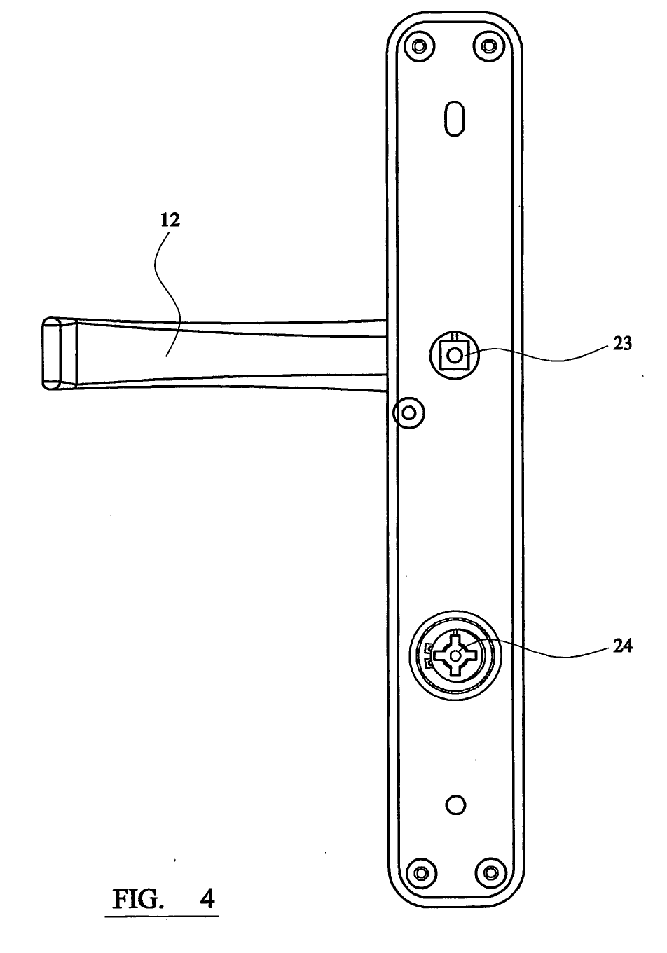

FIG. 4 is a view of the assembly of FIG. 2 from the rear;

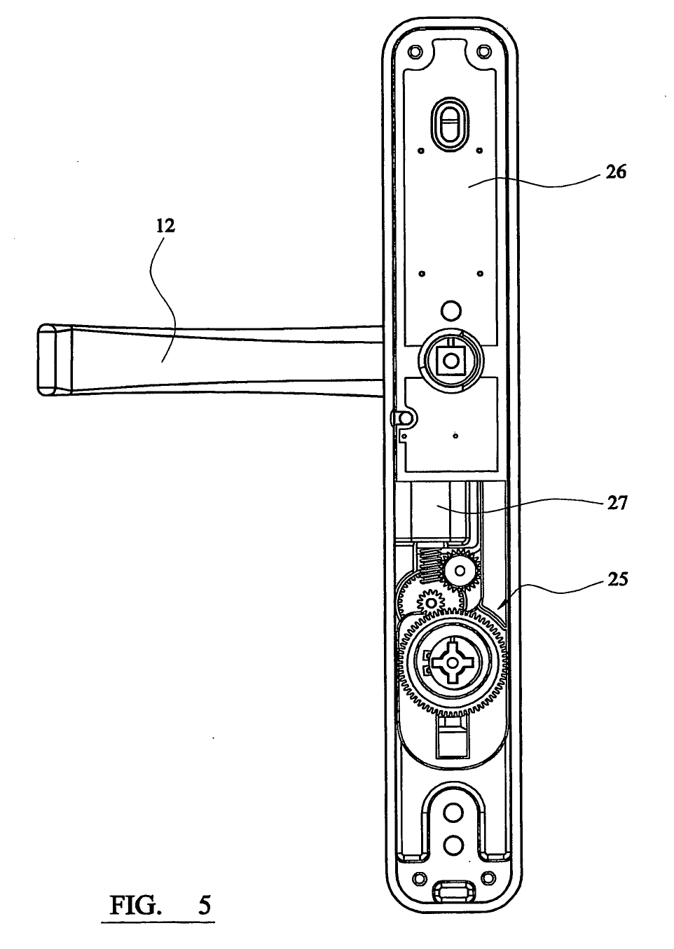

FIG. 5 is a view similar to FIG. 4 but with a gearbox lid removed;

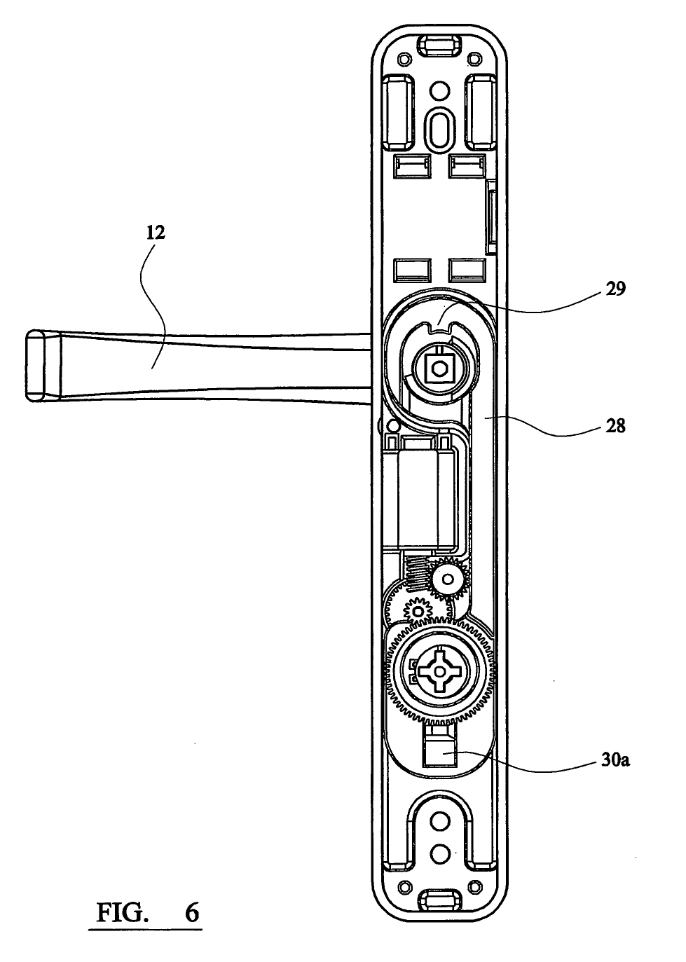

FIG. 6 is a view similar to FIG. 5 but with a printed circuit board also removed;

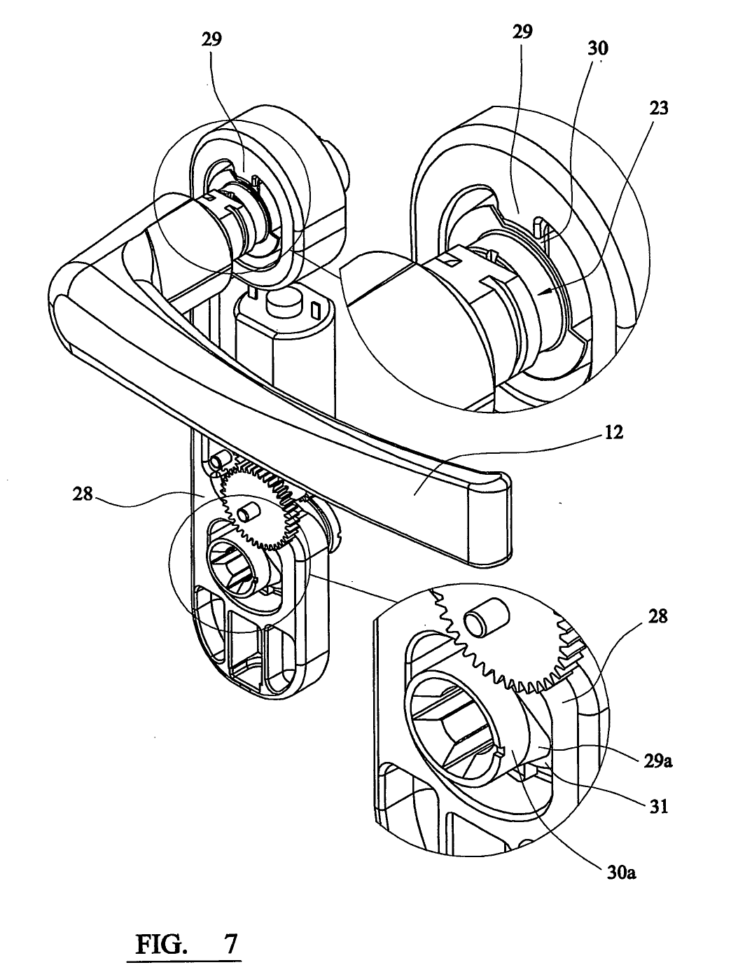

FIG. 7 is a perspective view of the locking mechanism with a gearbox in a locked position;

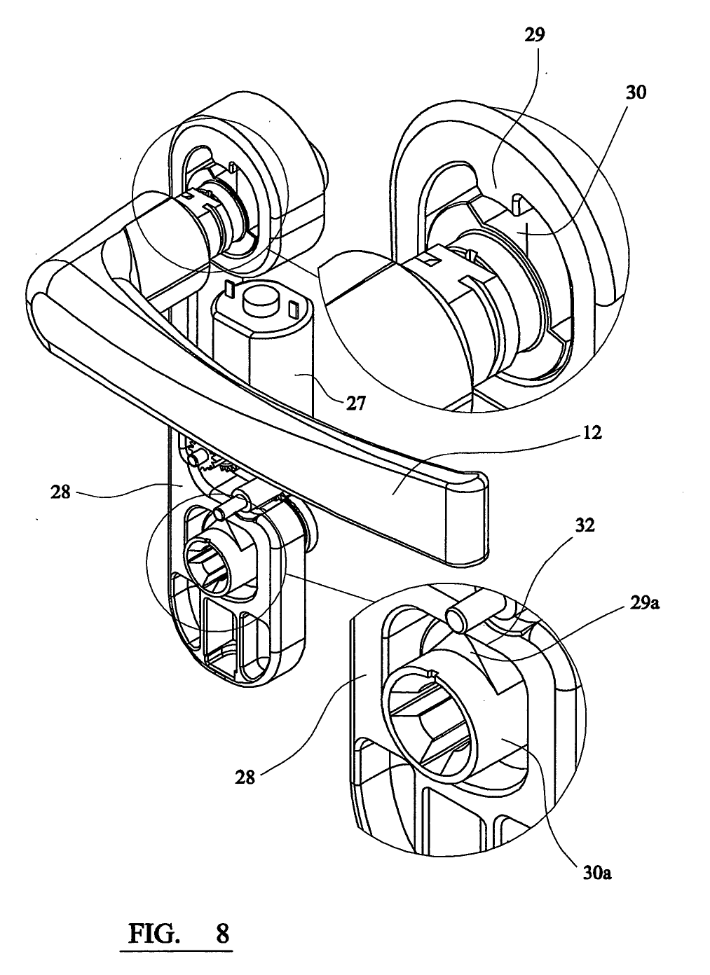

FIG. 8 is a view similar to FIG. 7 but showing the gearbox in an open position;

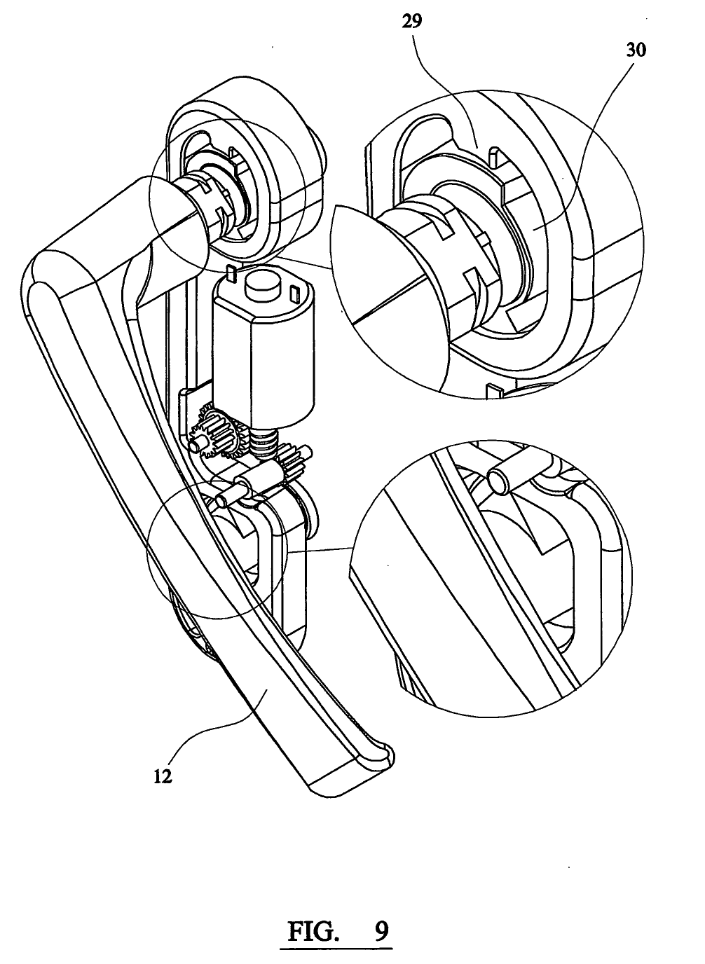

FIG. 9 is a view similar to FIG. 8 but showing an internal handle of the mechanism in a down position;

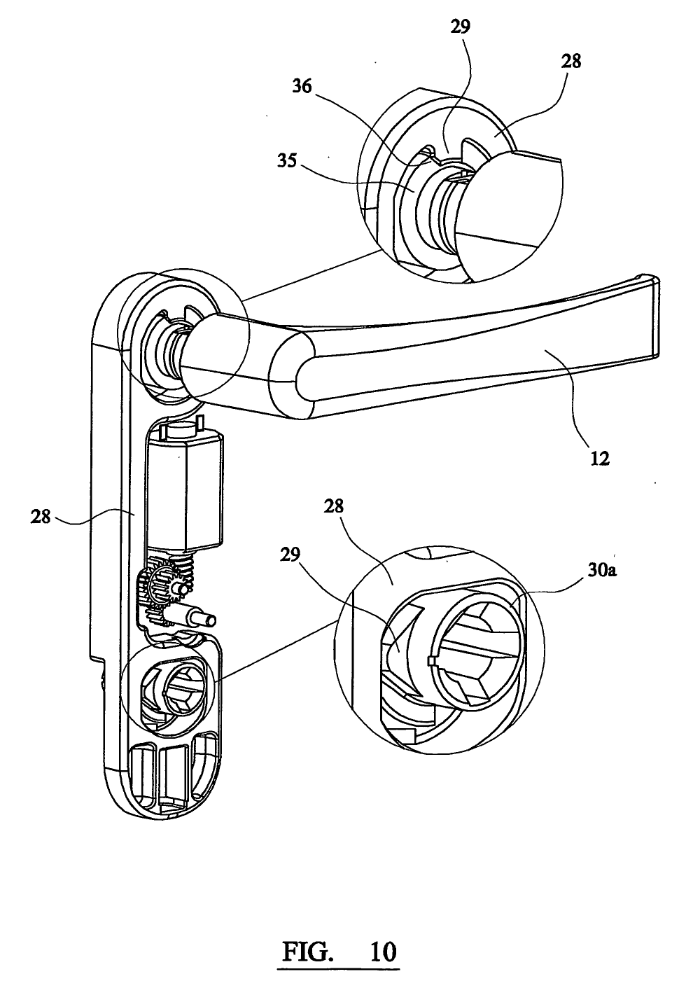

FIG. 10 is a perspective view with the gearbox shown in a day latch position, from the inside;

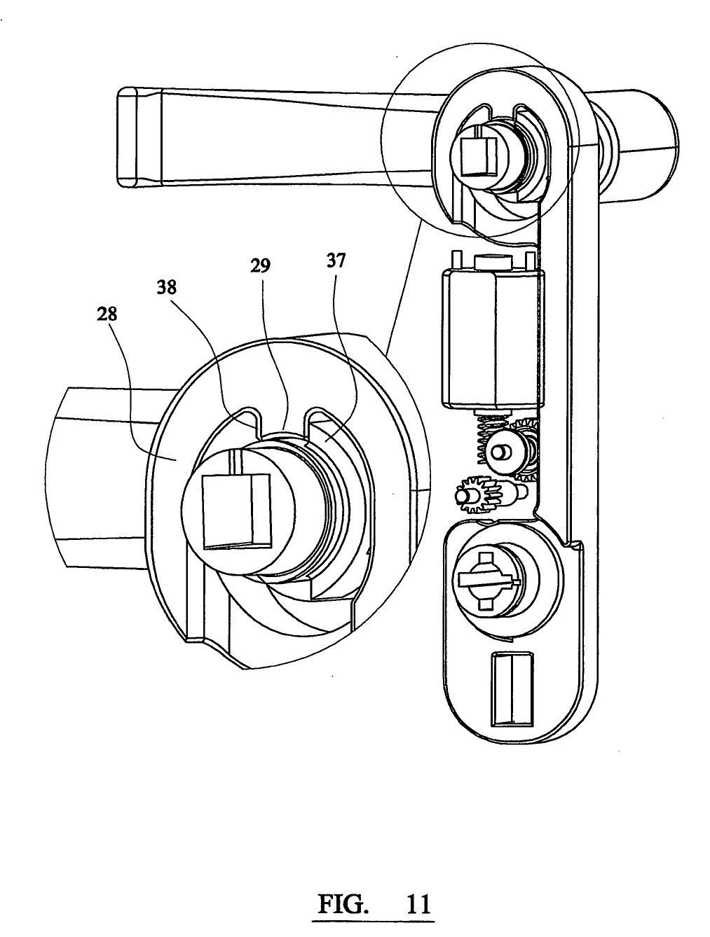

FIG. 11 is a view showing the gearbox in the day latch position, from the outside;

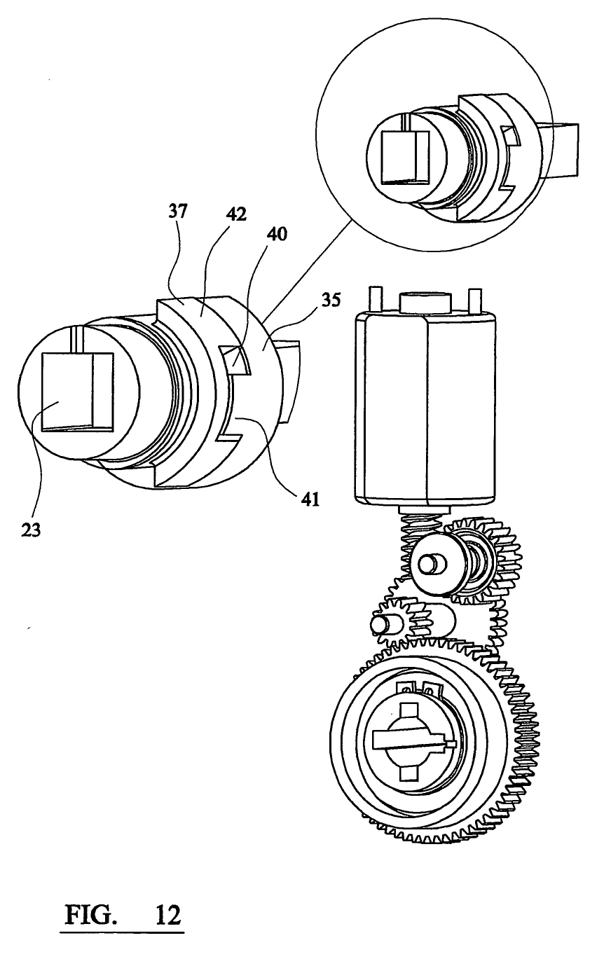

FIG. 12 is a perspective view of components of the locking mechanism, including a main clutch assembly, a motor clutch assembly, and a split hub assembly controlling inside and outside handles;

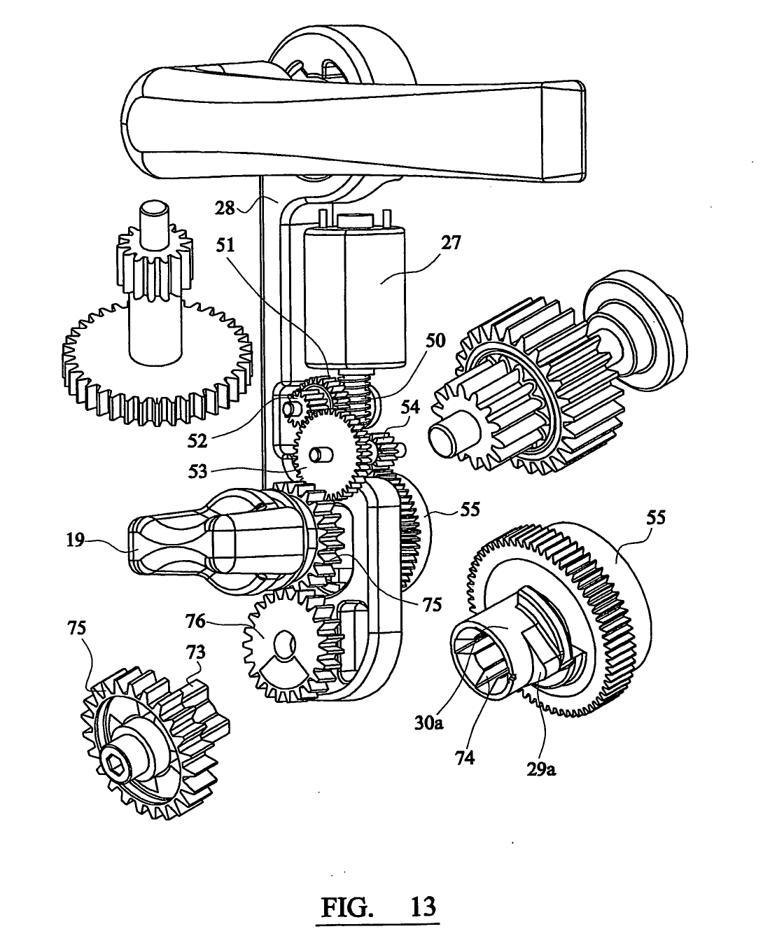

FIG. 13 is a sub assembly view of the gearbox of the locking mechanism;

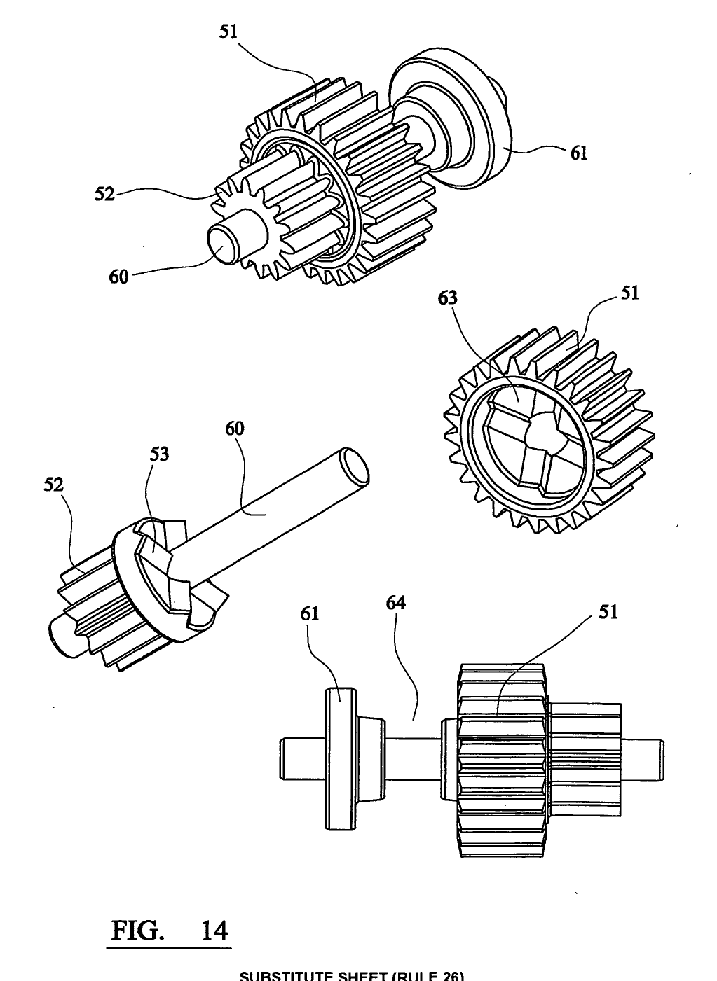

FIG. 14 shows components of the motor clutch assembly in more detail;

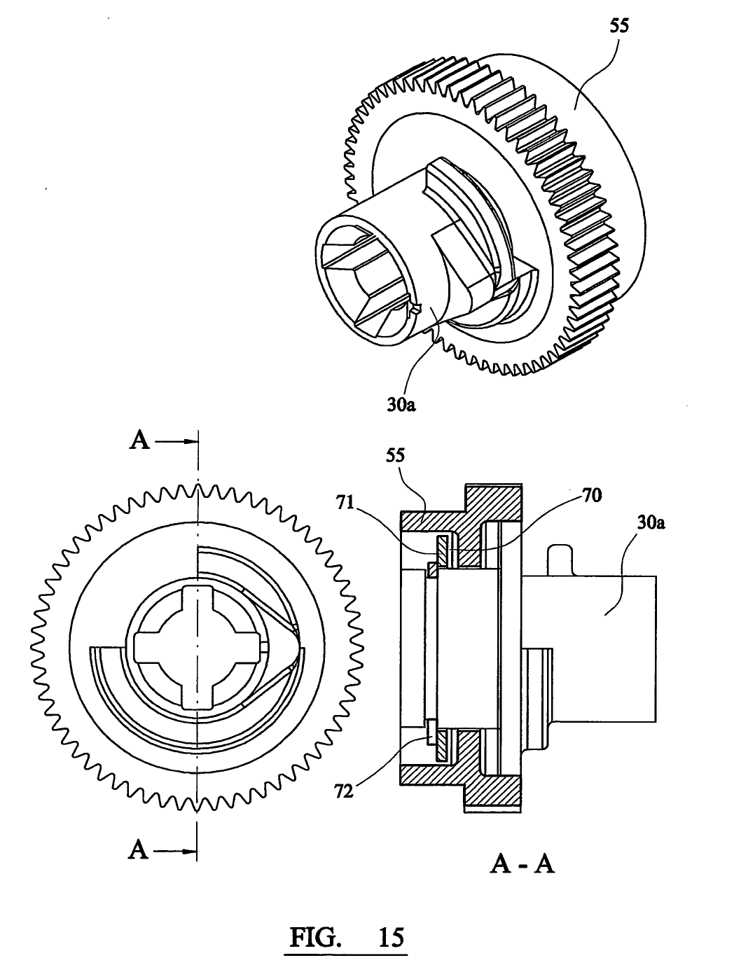

FIG. 15 shows components of the main clutch assembly in more detail; and

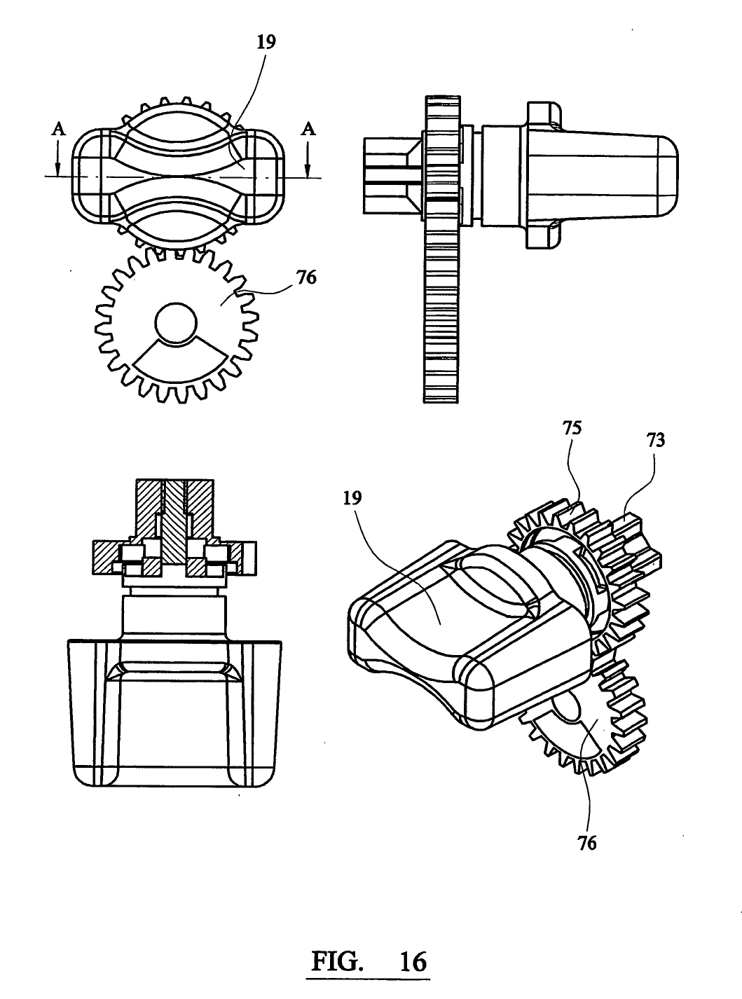

FIG. 16 shows in more detail components of a child proof device of the gearbox.

This embodiment of locking mechanism will be described in connection with a front door of a domestic home but the locking mechanism may of course be used with other doors, windows, or indeed any hinged panel which is to be locked to a frame.

The door shown in FIG. 1 comprises a panel 10 hinged to a frame 11. The door has an inner handle 12 attached to the locking mechanism 16 and there is also a similar external handle although this cannot be seen in the figures.

The door has a conventional spring catch 15, two conventional security hooks 17 and a dead bolt 18. The locking mechanism is associated with an operating fob 14 having a push button 13, shown in FIG. 1 to a larger scale.

In a conventional, unlocked condition, the internal handle 12, an external handle can be used to open and close the door, the spring catch 15 keeping the door closed when the panel 10 is flush within the frame 11.

If it is desired to engage the security hook 17, this can be done in a conventional manner, using an internal espagnolette (not shown) by pivoting the internal handle 12 or external handle upwardly.

In a conventional arrangement, upward pivotal movement of the handles would also engage the dead bolt 18, but in this embodiment of the invention, there is a novel and inventive relationship between the handles the dead bolt 18.

FIG. 2 is a detailed view of the locking mechanism from the inside, showing also a manual override knob 19 and an indicator window 20. The window may for example show red when the door is locked and green when the door is open.

FIG. 3 shows that if a back plate is removed from the locking mechanism 16, access can be gained to batteries 21 which power the electrical parts of the mechanism described later, and FIG. 3 also shows gears 22 which operate the locked/open indicator.

The novelty and inventiveness of this embodiment of locking mechanism concerns the relationship between a first spindle assembly 23 shown in FIG. 4, associated with the handles, and a second spindle assembly 24 associated with the dead bolt.

The locking mechanism incorporates a sophisticated gearbox to be described later. FIG. 5 shows the locking mechanism with the gearbox lid removed. The gearbox is indicated generally by the reference numeral 25. A printed circuit board 26 can also be seen which carries all the necessary electronic components to control the locking mechanism and its drive motor 27.

The two spindle assemblies are controlled by cooperation with a control member in the form of a link arm 28 shown in FIG. 6. The upper part of this link arm carries a downward projection 29 and the lower part of the arm has a slot 30a which receives a compression spring not shown, which in use biases the arm 28 into a downward position, shown in FIG. 7.

FIG. 7 also shows the handles in the locked position. The projection 29 engages in a recess 30 in the first spindle mechanism 23. The arm 28 is held in this downward position by a projection 29a on a cam 30a associated with the second spindle mechanism 24. The upward movement of the arm 28 is prevented because in the position shown in FIG. 7, the projection 29 lies on a lug 31 projecting inwardly from the arm 28.

FIG. 8 shows how the arm 28 can be moved upwardly into an open position, against the action of its biasing spring. This movement is achieved by using the motor 27 to rotate the cam 30 into a position in which a cam projection 29 pushes against a face 32 of the arm 28, raising the arm so that the projection 29 is lifted clear of the recess 30.

FIG. 9 shows how the handle 12 is free to move downwardly once the projection 29 is clear of the recess 30.

FIG. 10 shows a day latch position for the locking mechanism. In the day latch position, the projection 29a on the cam 30a is moved into a position in which it avoids all contact with the lever 28. Thus the lever 28 is only held in the lower position by the spring bias. In this day latch position the handle 12 can operate. This is because the portion of the first spindle assembly 23 associated with the inner handle, as indicated by the reference numeral 35 in FIG. 10, has a ramp portion 36. Downward rotation of the handle 12 causes the ramp portion 36 to ride over the projection 29, pushing it and the lever 28 into the upper position.

However, the external handle, not shown, cannot be moved during the day latch position. This is because the spindle portion 37 associated with the outer handle, as shown in FIG. 11, has no ramp portion. Thus, engagement of the projection 29 in a non-ramped recess 38 of the spindle portion 37 prevents any movement of the outer handle until the lever 28 has been moved upwardly by some other means.

FIG. 12 shows in detail the two portions 35 and 37 of the first spindle assembly 23. There is a degree of play 40 between inter-engaging dogs 41, 42 of the split spindle assembly. Without this play, movement of the inner handle 12, even in the day latch position, would be prevented by the inner spindle portion 35 locking up against the outer spindle portion 37.

FIG. 13 shows the gearbox assembly in more detail. The motor 27 drives a worm 50. This drives a cog 51 connected by a motor clutch (described later) to a smaller diameter cog 52. Cog 52 drives a large diameter cog 53 which in turn drives a smaller diameter cog 54. The teeth of cog 54 engage with the teeth of the drive member 55 which is connected to the cam 30a via a main clutch (also described later). alignment and the knob can only be used to operate the locking mechanism by first pushing the knob inwardly to engage the teeth 73 with the teeth 74.

The tooth component 75 is used to drive a visual indicator wheel 76.

This embodiment of the invention provides an extremely versatile locking mechanism which can also be linked to safety devices within the home, such as smoke detectors, burglar alarms or panic buttons. The mechanism can also be linked to mechanisms on other doors or windows so that more than one or more entry point can be controlled from a single location, for example the main front door of a house.

Because the main components of the door assembly itself are conventional, such as spring catch 15 and security hooks 17, a locking mechanism is according to the invention can readily be retrofitted to existing door assemblies.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A locking mechanism for use with at least one door and/or window of a structure, the mechanism comprising at least one operating handle and at least one electrical operating device.

2. A locking mechanism as claimed in claim 1, comprising at least one remote control device.

3. A locking mechanism as claimed in claim 2, comprising a fob which may be manually operated, e.g. by a householder from outside a building, to unlock a door or window.

4. A locking mechanism as claimed in claim 1, comprising a first rotatable member associated with the handle, a second rotatable member spaced from the first rotatable member and associated with a dead bolt, and a control member extending between the first and second rotatable members.

5. A locking mechanism as claimed in claim 4, in which the second rotatable member is movable into a tacking position in which it causes the control member to prevent operation of the handle.

6. A locking mechanism as claimed in claim 5, in which the second rotatable member is rotatable by means of a motor.

7. A locking mechanism as claimed in claim 6, in which the motor is associated with a gear train which provides a high mechanical advantage in favour of the motor, for example by incorporating a worm.

8. A locking mechanism as claimed in claim 4, incorporating a first clutch to enable the second operating member to be manually rotated if desired, notwithstanding the connection of the second rotatable member to the motor.

9. A locking mechanism as claimed in claim 4, incorporating second clutch arranged, to slip once the motor has moved the second rotatable member to a predetermined position, the change in electrical current to the motor, on slippage of the second clutch, providing a readily detectable and identifiable signal indicating that the motor has achieved its function.

10. A locking mechanism as claimed in claim 4, comprising a control link which, when the second rotatable member is in the locking position, is locked against movement by a cam associated with the second rotatable member, the other end of the control member locking the handle against movement.

11. A locking mechanism as claimed in claim 10, in which the control member operates to lock the handle against movement by the engagement of a projection in a recess.

12. A locking mechanism as claimed in claim 10, in which there is an internal handle and an external handle, both of which are locked against movement when the second rotatable member is in the locking position.

13. A locking mechanism as claimed in claim 12, in which the cam has a day latch position in which it does not prevent movement of the control member, but the control member is biased into a locking position.

14. A locking mechanism as claimed in claim 13, such that when the control member is biased into the locking position, the external handle cannot be moved, but the projection end recess locking the internal handle are such that there is a ramp surface so that the internal handle can be moved, the associated projection riding along the ramp and out of the recess.

15. A locking mechanism as claimed in claim 14, such that operation of the fob causes the control member to move into a position in which the projection is clear of the recess and both the internal and external handles can be operated.

16. A locking mechanism as claimed in claim 15, such that after a door has been opened using the fob, and then closed, the locking mechanism moves into the day latch condition.

17. A locking mechanism as claimed in claim 16, in which there is a short delay before the locking mechanism moves into the day latch position, for example from 5 to 10 seconds.

18. A locking mechanism as claimed in claim 1, associated with internal safety devices, for example at least one smoke detector, at least one burglar alarm and at least one panic button.

19. A locking mechanism as claimed in claim 1, linked to other locking mechanisms on other doors and/or windows, so that several entry points on a structure may be controlled from a single locking mechanism, for example using a fob associated with that locking mechanism.

20. A locking mechanism as claimed in claim 4, in which the second rotatable member is manually rotatable by a knob, the knob being arranged so that it is difficult for a small child to operate.

21. A locking mechanism as claimed in claim 20, in which it is necessary to press the knob in and keep the knob pressed in before it is turned.

22. A locking mechanism as claimed in claim 21, such that pressing the knob in causes one drive gear associated with the second rotatable mechanism to engage with another such drive gear.

23. (canceled)

24. A movable panel such as a door or window, fitted with a locking mechanism for use with at least one door and/or window of a structure, the mechanism comprising at least one operating handle and at least one electrical operating device.

25. A structure fitted with a locking mechanism for use with at least one door and/or window of a structure, the mechanism comprising at least one operating handle and at least one electrical operating device.
